(19) United States
(12) Patent Application Publication
(10) Pub. No.: US 2023/0104081 A1
(43) Pub. Date: Apr. 6, 2023

(54) DYNAMIC IDENTITY ASSIGNMENT SYSTEM FOR COMPONENTS OF AN INFORMATION HANDLING SYSTEM (IHS) AND METHOD OF USING THE SAME

(71) Applicant: Dell Products, L.P., Round Rock, TX (US)

(72) Inventors: Sudhir Vittal Shetty, Cedar Park, TX (US); Pushkala Iyer, Round Rock, TX (US); Reginald H. Stumpe, JR., Round Rock, TX (US)

(73) Assignee: Dell Products, L.P., Round Rock, TX (US)

(21) Appl. No.: 17/491,669

(22) Filed: Oct. 1, 2021

(51) Int. Cl. G06Q 10/08

(52) U.S. Cl. CPC G06Q 10/0875

(57) ABSTRACT

According to one embodiment, a dynamic identity assignment system for an Information Handling System (IHS) with hardware components includes computer-executable code to obtain an inventory of the hardware components in which the inventory comprises information associated with a configuration of each of the hardware components in the IHS. The code also receives one or more rule definitions, and for each of the hardware components, generates an identity-based attribute for the hardware component by matching the configuration of the hardware component with at least one of the rule definitions, and assigning the generated identity-based attribute to the hardware component.

### FIELD

The present disclosure relates generally to Information Handling Systems (IHSs), and more particularly, to a dynamic identity assignment system for components of an Information Handling System (IHS) and method of using the same.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments are typically provided by a remotely configured system management consoles. Openmanage Enterprise is one example of a system management console provided by Dell Technologies, which cost-effectively facilitates comprehensive lifecycle management for the hardware components of distributed computing environments from one console.

These large computing environments have become an increasingly important aspect of the current economy. Among the advantages of such computing environments are their ability to handle a variety of different computing scenarios including large computational problems, high volume data processing situations, and high availability (HA) situations. Such distributed computing systems typically utilize numerous hardware components in support of the computing environment. Additionally, in an effort to aggregate such hardware components and to make them more manageable and flexible, systems managers are often used to coordinate the operation of such numerous devices.

### SUMMARY

According to one embodiment, a dynamic identity assignment system for an Information Handling System (IHS) with hardware components includes computer-executable code to obtain an inventory of the hardware components in which the inventory comprises information associated with a configuration of each of the hardware components in the IHS. The code also receives one or more rule definitions, and for each of the hardware components, generates an identity-based attribute for the hardware component by matching the configuration of the hardware component with at least one of the rule definitions, and assigning the generated identity-based attribute to the hardware component.

According to another embodiment, a dynamic identity assignment method includes the steps of obtaining an inventory of a plurality of hardware components of an Information Handling System (IHS), and receiving one or more rule definitions. The inventory comprises information associated with a configuration of each of the hardware components in the IHS. The method also includes the steps of, for each of the hardware components, generating an identity-based attribute for the hardware component by matching the configuration of the hardware component with at least one of the rule definitions, and assigning the generated identity-based attribute to the hardware component.

According to yet another embodiment, a systems manger appliance includes computer-readable instructions for obtain an inventory of a plurality of hardware components each having at least one identity-based attribute in which the inventory comprises information associated with a configuration of each of the hardware components in an Information Handling System (IHS). The computer-readable instructions also receive one or more rule definitions and for each of the hardware components, generate an identity-based attribute for the hardware component by matching the configuration of the hardware component with at least one of the rule definitions, and assign the generated identity-based attribute to the hardware component.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram illustrating certain components of a chassis comprising one or more compute sleds and one or more storage sleds that may be configured to provide a dynamic identity assignment system according to one embodiment of the present disclosure.

FIG. 2 shows an example of an IHS configured to implement systems and methods described herein for supporting validation of the secure assembly and delivery of the IHS.

FIG. 3 is a diagram view illustrating several components of an example dynamic identity assignment system according to one embodiment of the present disclosure.

FIG. 4 illustrates an example hardware component group structure that the hardware components of the IHS may be arranged in according to one embodiment of the present disclosure.

FIG. 5 illustrates a flowchart depicting certain steps of one embodiment of a dynamic identity assignment method according to one embodiment of the present disclosure.

### DETAILED DESCRIPTION

Embodiments of the present disclosure provide a dynamic identity assignment system and method that dynamically configures the identity-based attributes of the hardware components of an Information Handling System (IHS). Large IHSs, such as server farms, may possess a relatively large number of hardware components, and each of these hardware components often possesses certain identity-based attributes (e.g., WWDN, WWN, IP address, MAC address, iSCSI initiator Address, etc.) whose identity-based attributes should be coordinated in order to provide efficient management of the IHSs. The dynamic identity assignment system provides a solution to this problem, among others, by coordinating the naming of identity-based attributes of hardware components according to a configuration of those hardware components thus providing enhanced flexibility for naming conventions associated with those identity-based attributes.

Currently implemented computing environments, such as one implemented with a MX-7000 computing chassis provided by Dell Technologies, may include a large quantity of hardware components. For example, a fully scaled configuration of the MX-7000 may have up to 160 sleds and 24 I/O modules configured in 20 chassis. Furthermore each of the sleds is often configured with multiple individual hardware components. Management of a large, diversified computing environment such as this is typically provided by a remotely configured system management console. OpenManage Enterprise is one example of a systems manager provided by Dell Technologies, which cost-effectively facilitates comprehensive lifecycle management for the hardware components of IHSs from a single console. While such systems management consoles have been an effective tool for remotely managing a computing environment, their use with relatively large numbers of hardware components can sometimes become unwieldy.

Many currently used hardware components in an IHS utilize identity-based attributes that enables them to function with one another, and be remotely managed. For example, storage components can be configured with a World Wide Name (WWN), while I/O ports can be configured with a World Wide Port Name (WWPN) to uniquely identify and manage each other from a management console. It would be beneficial to provide a naming scheme for such components with certain meaningful lexical semantic constructs that are easy to remember and categorize by a user. For example, a particular hardware component dedicated for use by the accounting department of an organization having a wwpn of ‘0x30c450ef43777-acct’ would be easier to remember than a mere raw serial number of ‘0x30c450ef43777.’ It would also be beneficial to coordinate the naming of large numbers of hardware components using a specific configuration of the underlying hardware component based on user-selectable criteria that is dynamically adaptable to account for ongoing changes that often occur in organizations that use large IHSs, such as the computing environments discussed herein above. It is with these features in mind that embodiments of the present disclosure are disclosed herein.

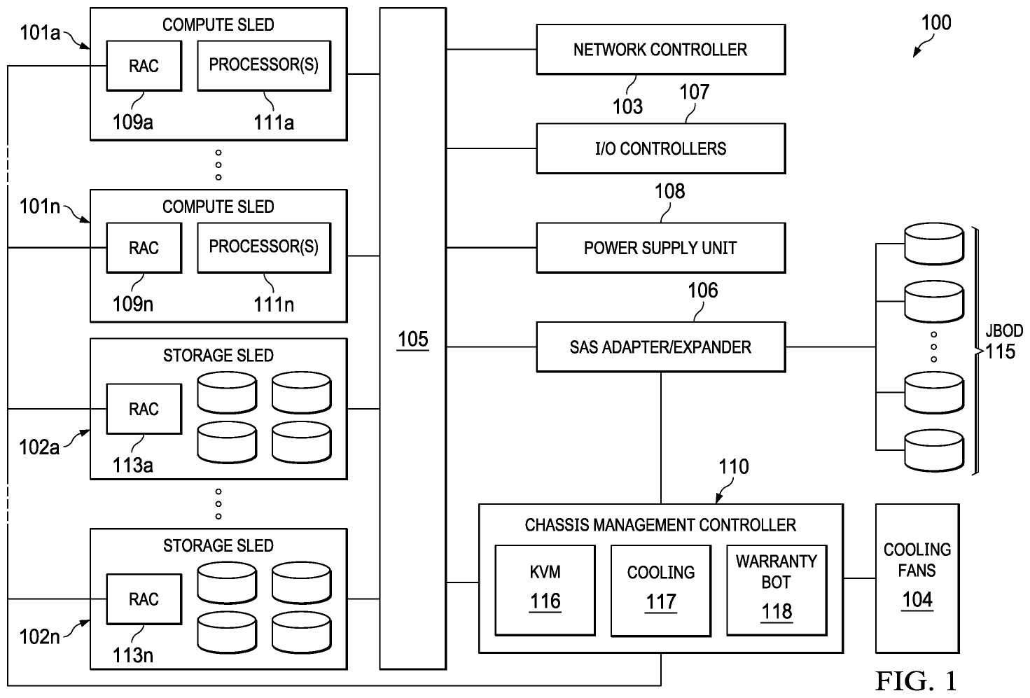

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, that may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAS (Serial Attached SCSI) adapter/expander 106, I/O controllers 107, and power supply unit 108.

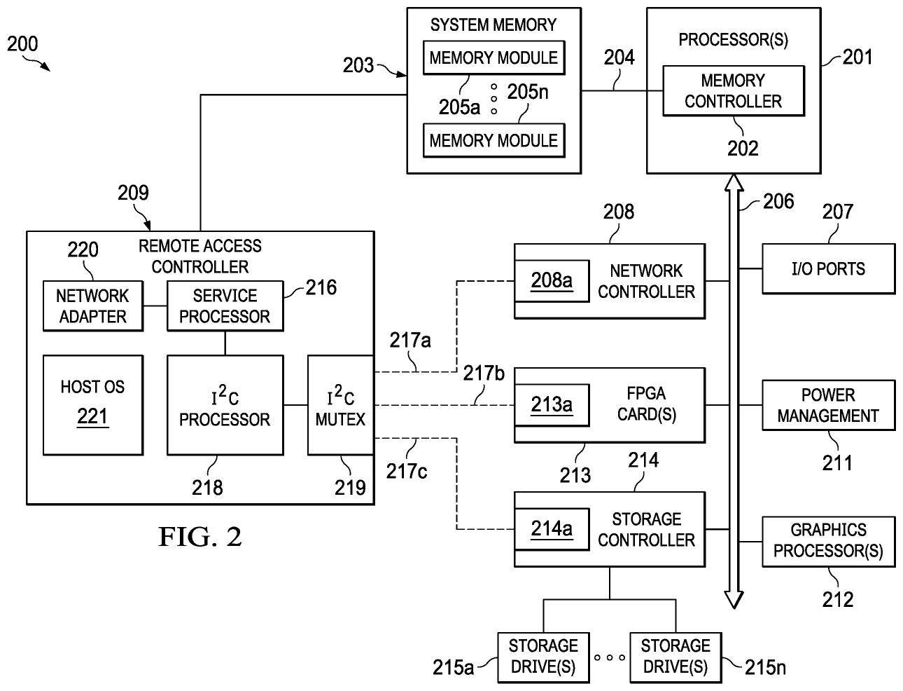

In certain embodiments, a compute sled 101a-n may be an IHS, such as described with regard to IHS 200 of FIG. 2. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. As described in additional detail with regard to FIG. 2, a remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Also as described in additional detail with regard to FIG. 2, remote access controllers 109a-n may support communications with chassis management controller 110 where these communications may report on the status of hardware and software systems on a particular sled 101a-n, 102a-n, such as information regarding warranty coverage for a particular hardware and/or software system.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments. Using such specialized processor capabilities of a compute sled 101a-n, a chassis 100 may be adapted for a particular computing solution.

In some embodiments, each compute sled 101a-n may include a storage controller that may be utilized to access storage drives that are accessible via chassis 100. Some of the individual storage controllers may provide support for RAID (Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS expander 106 that is coupled to backplane 105 of chassis 100. For example, SAS expander 106 may support connections to a number of JBOD (Just a Bunch Of Disks) storage drives 115 that may be configured and managed individually and without implementing data redundancy across the various drives 115. The additional storage resources 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network bandwidth 103, power 108, and airflow cooling 104 that are available via the chassis 100. As described, the airflow cooling 104 utilized by chassis 100 may include an airflow cooling system that is provided by a rack in which the chassis 100 may be installed and managed by a cooling module 117 of the chassis management controller 110.

As described, components of chassis 100 such as compute sleds 101a-n and storage sleds 102a-n may include remote access controllers 109a-n, 113a-n that may collect information regarding the warranties for hardware and software systems on each sled. Chassis management controller 110 may similarly collect and report information regarding the warranties for hardware and software systems on each sled.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail with respect to FIG. 2.

IHSs 107a-d may be used to support a variety of e-commerce, multimedia, business, and scientific computing applications. In some cases, these applications may be provided as services via a cloud implementation. IHSs 107a-d are typically configured with hardware and software that provide leading-edge computational capabilities. IHSs 107a-d may also support various numbers and types of storage devices. Accordingly, services provided using such computing capabilities are typically provided as high-availability systems that operate with minimum downtime. The warranties provided by vendors of IHSs 107a-d and the related hardware and software allow the data centers 101a-d to provide contracted Service Level Agreement (SLA) to customers. Upon failure of an IHS 107a-d, data centers 101a-d and operations center 102 typically relies on a vendor to provide warranty support in order to maintain contracted SLAs.

FIG. 2 illustrates an example IHS 200 configured to implement the systems and methods described herein. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 101a-n, that is configured to share infrastructure resources provided by a chassis 100 in support of specific computing solutions.

IHS 200 may be a compute sled that is installed within a large system of similarly configured IHSs that may be housed within the same chassis, rack and/or data center. IHS 200 may utilize one or more processors 201. In some embodiments, processors 201 may include a main processor and a co-processor, each of which may include a plurality of processing cores that, in certain scenarios, may each be used to run an instance of a server process. In certain embodiments, one, some or all processor 201 may be graphics processing units (GPUs). In some embodiments, one, some or all processor 201 may be specialized processors, such as artificial intelligence processors or processor adapted to support high-throughput parallel processing computations. As described, such specialized adaptations of IHS 200 may be used to implement specific computing solutions support by the chassis in which IHS 200 is installed.

As illustrated, processor 201 includes an integrated memory controller 202 that may be implemented directly within the circuitry of the processor 201, or memory controller 202 may be a separate integrated circuit that is located on the same die as the processor 201. Memory controller 202 may be configured to manage the transfer of data to and from a system memory 203 of the IHS 201 via a high-speed memory interface 204.

System memory 203 is coupled to processor 201 via a memory bus 204 that provides the processor 201 with high-speed memory used in the execution of computer program instructions by the processor 201. Accordingly, system memory 203 may include memory components, such as such as static RAM (SRAM), dynamic RAM (DRAM), or NAND Flash memory, suitable for supporting high-speed memory operations by the processor 201. In certain embodiments, system memory 203 may combine both persistent, non-volatile memory, and volatile memory.

In certain embodiments, system memory 203 may be comprised of multiple removable memory modules. System memory 203 in the illustrated embodiment includes removable memory modules 205a-n. Each of the removable memory modules 205a-n may correspond to a printed circuit board memory socket that receives a removable memory module 205a-n, such as a DIMM (Dual In-line Memory Module), that can be coupled to the socket and then decoupled from the socket as needed, such as to upgrade memory capabilities or to replace faulty components. Other embodiments of IHS system memory 203 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 201. All or portions of the chipset may be implemented directly within the integrated circuitry of an individual processor 201. The chipset may provide the processor 201 with access to a variety of resources accessible via one or more buses 206. Various embodiments may utilize any number of buses to provide the illustrated pathways served by bus 206. In certain embodiments, bus 206 may include a PCIe (PCI Express) switch fabric that is accessed via a PCIe root complex. IHS 200 may also include one or more I/O ports 207, such as PCIe ports, that may be used to couple the IHS 200 directly to other IHSs, storage resources or other peripheral components. In certain embodiments, the I/O ports 207 may provide couplings to the backplane of the chassis in which the IHS 200 is installed.

As illustrated, a variety of resources may be coupled to the processor 201 of the IHS 200 via bus 206. For instance, processor 201 may be coupled to a network controller 208, such as provided by a Network Interface Controller (NIC) that is coupled to the IHS 200 and allows the IHS 200 to communicate via an external network, such as the Internet or a LAN. As illustrated, network controller 208 may report information to a remote access controller 209 via an out-of-band signaling pathway that is independent of the operating system of the IHS 200.

Processor 201 may also be coupled to a power management unit 211 that may interface with power system unit 108 of chassis 100 in which an IHS 200, such as a compute sled 101a-n, may be installed. In certain embodiments, a graphics processor 212 may be comprised within one or more video or graphics cards, or an embedded controller, installed as components of IHS 200. In certain embodiments, graphics processor 212 may be an integrated of the remote access controller 209 and may be utilized to support the display of diagnostic and administrative interfaces related to IHS 200 via display devices that are coupled, either directly or remotely, to remote access controller 209.

As illustrated, IHS 200 may include one or more FPGA (Field-Programmable Gate Array) card(s) 213. Each of the FPGA cards 213 supported by IHS 200 may include various processing and memory resources, in addition to an FPGA integrated circuit that may be reconfigured after deployment of IHS 200 through programming functions supported by FPGA card 213. Each individual FGPA card 213 may be optimized to perform specific processing tasks, such as specific signal processing, security, data mining, and artificial intelligence functions, and/or to support specific hardware coupled to IHS 200. In certain embodiments, such specialized functions supported by an FPGA card 213 may be utilized by IHS 200 in support of certain computing solutions. As illustrated, FPGA 213 may report information to the remote access controller 209 via an out-of-band signaling pathway that is independent of the operating system of the IHS 200.

IHS 200 may also support one or more storage controllers 214 that may be utilized to provide access to virtual storage configurations. For instance, storage controller 214 may provide support for RAID (Redundant Array of Independent Disks) configurations of storage devices 215a-n, such as storage drives provided by storage sleds 102a-n and/or JBOD 115 of FIG. 1. In some embodiments, storage controller 214 may be an HBA (Host Bus Adapter). Storage controller 214 may report information to the remote access controller 209 via an out-of-band signaling pathway that is independent of the operating system of the IHS 200.

In certain embodiments, IHS 200 may operate using a BIOS (Basic Input/Output System) that may be stored in a non-volatile memory accessible by the processor(s) 201. The BIOS may provide an abstraction layer by which the operating system of the IHS 200 interfaces with the hardware components of the IHS. Upon powering or restarting IHS 200, processor 201 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 209.

In certain embodiments, remote access controller 209 may operate from a different power plane from the processors 201 and other components of IHS 200, thus allowing the remote access controller 209 to operate, and management tasks to proceed, while the processing cores of IHS 200 are powered off. As described, various functions provided by the BIOS, including launching the operating system of the IHS 200, may be implemented by the remote access controller 209. In some embodiments, the remote access controller 209 may perform various functions to verify the integrity of the IHS 200 and its hardware components prior to initialization of the IHS 200 (i.e., in a bare-metal state).

Remote access controller 209 may include a service processor 216, or specialized microcontroller, that operates management software that supports remote monitoring and administration of IHS 200. Remote access controller 209 may be installed on the motherboard of IHS 200 or may be coupled to IHS 200 via an expansion slot provided by the motherboard. In support of remote monitoring functions, network adapter 208c may support connections with remote access controller 209 using wired and/or wireless network connections via a variety of network technologies.

In some embodiments, remote access controller 209 may support monitoring and administration of various devices 208, 213, 214 of an IHS via a sideband interface. In such embodiments, the messages in support of the monitoring and management function may be implemented using MCTP (Management Component Transport Protocol) that may be transmitted using I2C sideband bus connections 217a-c established with each of the respective managed devices 208, 213, 214. As illustrated, the managed hardware components of the IHS 200, such as FPGA cards 213, network controller 208 and storage controller 214, are coupled to the IHS processor 201 via an in-line bus 206, such as a PCIe root complex, that is separate from the I2C sideband bus connection 217a-c.

In certain embodiments, the service processor 216 of remote access controller 209 may rely on an I2C co-processor 218 to implement sideband I2C communications between the remote access controller 209 and managed components 208, 213, 214 of the IHS. The I2C co-processor 218 may be a specialized co-processor or micro-controller that is configured to interface via a sideband I2C bus interface with the managed hardware components 208, 213, 214 of IHS. In some embodiments, the I2C co-processor 218 may be an integrated component of the service processor 216, such as a peripheral system-on-chip feature that may be provided by the service processor 216. Each I2C bus 217a-c is illustrated as single line in FIG. 2. However, each I2C bus 217a-c may be comprised of a clock line and data line that couple the remote access controller 209 to I2C endpoints 208a, 213a, 214a.

As illustrated, the I2C co-processor 218 may interface with the individual managed devices 208, 213, and 214 via individual sideband I2C buses 217a-c selected through the operation of an I2C multiplexer 219. Via switching operations by the I2C multiplexer 219, a sideband bus connection 217a-c may be established by a direct coupling between the I2C co-processor 218 and an individual managed device 208, 213, or 214.

In providing sideband management capabilities, the I2C co-processor 218 may each interoperate with corresponding endpoint I2C controllers 208a, 213a, 214a that implement the I2C communications of the respective managed devices 208, 213, 214. The endpoint I2C controllers 208a, 213a, 214a may be implemented as a dedicated microcontroller for communicating sideband I2C messages with the remote access controller 209, or endpoint I2C controllers 208a, 213a, 214a may be integrated SoC functions of a processor of the respective managed device endpoints 208, 213, 214.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor 201 as a systems-on-a-chip.

In some embodiments, the remote access controller 209 may include or may be part of a baseboard management controller (BMC). As a non-limiting example of a remote access controller 209, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 209 may be used to monitor, and in some cases manage computer hardware components of IHS 200. Remote access controller 209 may be programmed using a firmware stack that configures remote access controller 209 for performing out-of-band (e.g., external to a computer's operating system or BIOS) hardware management tasks. Remote access controller 209 may run a host operating system (OS) 221 on which various agents execute. The agents may include, for example, a service module 250 that is suitable to interface with remote access controller 209 including, but not limited to, an iDRAC service module (iSM).

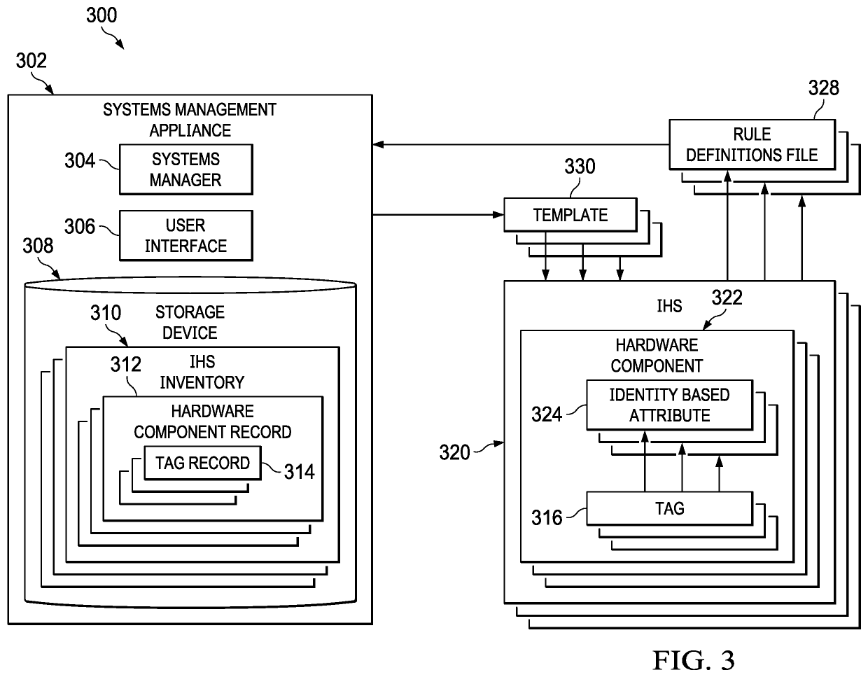

FIG. 3 is a diagram view illustrating several components of an example dynamic identity assignment system 300 according to one embodiment of the present disclosure. The dynamic identity assignment system 300 includes a systems management appliance 302 that manages the operation of one or more IHSs 320, such as a computing environment. In one embodiment, the IHSs 320 may be similar in design and construction to IHS 100 or IHS 200 described above with respect to FIGS. 1 and 2. In a particular embodiment, the IHS 100 may include at least a portion of a stacked (e.g., scaled) computing chassis comprising multiple, individual chassis, such as the MX-7000 computing chassis provided by Dell Technologies.

The systems management appliance 302 includes a systems manager 304, a user interface 306, and a storage device 308. The systems manager 304 monitors and controls the operation of each of the IHSs 320. In one embodiment, the systems manager 304 includes at least a portion of the Dell EMC OpenManage Enterprise (OME) that is installed on a secure virtual machine (VM), such as a VMWARE Workstation. Storage device 308 stores IHS inventories 310 for each of multiple IHSs 100 managed by the systems manager 304. Each IHS inventory 310 stores hardware component records 312 associated with each of multiple hardware components 322 configured in their respective IHS 320. For example, the hardware components 322 may each be one of an FPGA card 220, a network controller 225, a storage controller 230, a compute sled 105a, a storage sled 115a, or the like.

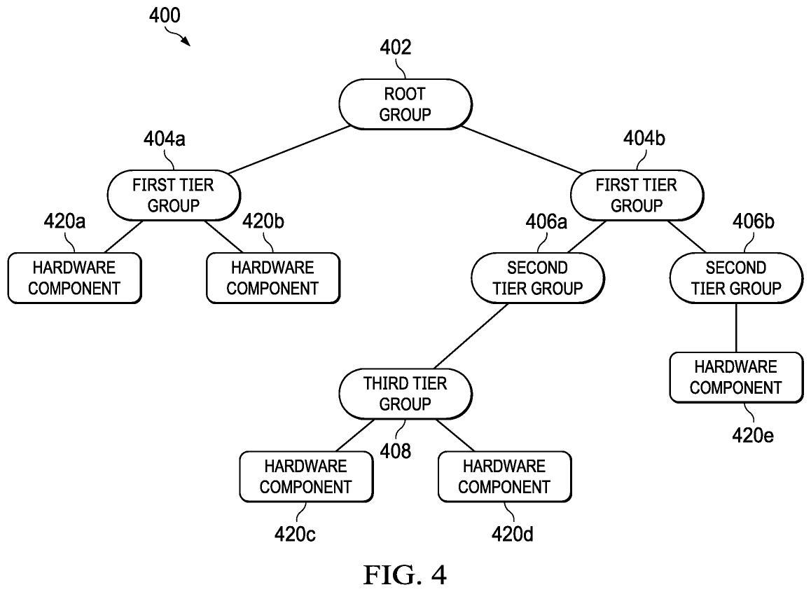

Each hardware component record 312 may also store tag records 314 associated with any tags 316 configured on its respective hardware component 322. For example, one tag record 314 may be associated with a group designation as described above with reference to FIG. 4 described herein below. Additionally, the tag record 314 may include information associated with a static (non-changing) group designation or a dynamic (modifiable) group designation. As another example, the tag records 314 may be associated with tags 316 configured to designate its respective hardware component 322 according to a user-defined criteria, a usage criteria, and/or a location criteria.

Each hardware component 322 includes one or more identity-based attributes 324 that performs at least one aspect of identifying its respective hardware component from among other hardware components 322 in the IHS 320. Examples of such identity-based attributes 324 may include an IP address and/or a MAC address of an Ethernet port configured on the hardware component 322, a WWN of a storage component configured on the hardware component 322, a WWPN used to uniquely identify an I/O port configured on the hardware component 322, an iSCSI initiator IQN, and/or an iSCSI initiator IP address. In some embodiments, the identity-based attribute 324 may be or include part of a name (e.g., host OS name, network name, user names, etc.) assigned to the hardware component 322.

According to embodiments of the present disclosure, the systems manager 304 is configured to receive one or more rules stored in a rule definition file 328, and use those rules to generate identity-based attributes 324 for the hardware component 322 by matching the configuration of its respective hardware component 322 with at least one of the rules, and assigning the generated identity-based attribute to the hardware component 322. In one embodiment, the systems manager 304 may create a template file 330 for each IHS 320 managed by the systems manager 304 in which the template file 330 stores the generated identity-based attributes for assignment to the hardware components 322 at a later time.

Because the IHS 320 may possess many hardware components 322, it would be beneficial to provide a naming scheme for such components with certain meaningful lexical semantic constructs that are easy to remember and categorize by a user. Whereas traditional naming schemes for the identity-based attributes 324 only allowed basic identity configuration from a pool of available identity-based attributes (e.g., start address of AA:BB:CC:DD:EE:FF and 500 entries), it did not possess flexibility in terms of identity selection and driving it based on the inventory of the IHS 320, group membership, or tags as may be provided by embodiments of the dynamic identity assignment system described herein.

The dynamic identity assignment system 300 provides for the flexible definitions of both a pool of available identity-based attributes by implementing a matching criteria that is used to generate an identity-based attribute using a configuration of its respective hardware component 322. In one embodiment, the dynamic identity assignment system 300 implements a matching criteria that, using the configuration of the hardware component 322, selects an identity-based attribute from a pool of available identity-based attributes. In one embodiment, the user may be able to define a regular expression corresponding to a pool identity-based attribute entry that matches a certain pattern. For example, the user may include an entry in the rule definition file 328 in the form of a regular expression (E.g., AA:BB:CC:DD:*:01 defining certain MAC addresses that should have a suffix of ‘:01’). In some cases, the definition of matching rules could leverage certain attributes to match the inventory of the hardware component 322. For example, an entry in the rule definition file 328 may define an integrated NIC device to be, for example, ‘NIC.FQDD=NIC. Integrated.1-1’ to match the first port of that integrated NIC. This could also be used more generically to match other aspects of the IHS inventory (e.g., host OS name, model of hardware component 322, physical/logical position of the hardware component 322 in the IHS 320, etc.). In one embodiment, a group membership of a hardware component 322 and/or any associated tags could be used to match hardware components 322 based on its operational usage, location, or any user-defined tag (e.g., static, dynamic, query-based, etc.) on a group.

In one embodiment, certain rules in the rule definition file 328 may be in the form of a regular expression that is applied to generate an identity-based attribute 324. In another embodiment, certain rules in the rule definition file 328 may include conditional clauses indicating that the rule is applied when certain conditions are met. For example, one rule may include a regular expression of “Pheonix-*” that is coupled with a conditional clauses of “if location=Pheonix, AZ” and “if hardware component=compute device” such that if a compute device hardware component 322 is encountered that is located on an IHS 320 in Pheonix, Ariz., the name (e.g., identity-based attribute) assigned to the host OS name of that compute device hardware component 322 will be imparted with a Pheonix-′ prefix.

In one embodiment, the rule definitions file 328 may include information associated with pools of identity definitions to be applied to certain identity-based attributes 324. The rule definitions file 328 may include, for example, a range of available identity-based attributes, such as a range of IP addresses with a specified start IP address coupled with a quantity of allowed entries (e.g., 500). Thus, most or all IP addresses assigned to the hardware components 322 of the target IHS 320 may be assigned to exist within that range of allowable IP addresses. The rule definitions file 328 may be extended to include other such identity-based attributes 324, such as to MAC addresses, iSCSI initiator IQN values, iSCSI initiator IP address values, WWN addresses, WWPN addresses, and the like.

FIG. 4 illustrates an example hardware component group structure 400 that the hardware components 322 of the IHS 320 may be arranged in according to one embodiment of the present disclosure. The structure 400 includes a root group 402 along with multiple hierarchically arranged groups including two first tier groups 404a, 404b, two second tier groups 406a, 406b, and one third tier group 408. Additionally, two hardware components 420a, 420b are arranged in the first tier group 404a, two hardware components 420c, 420d are arranged in the third tier group 408, and one hardware component 420e is arranged in the second tier group 406b.

The hierarchical arrangement of the structure 400 provides a technique for grouping hardware components with a greater level of granularity than provided by conventional structuring of hardware components by a systems manager. For example, the first tier group 404b may be allocated to a national region (e.g., United States), the second tier group 406a may be allocated according to a particular sub-region (e.g., Texas) of the first tier group 404b, while the third tier group 408 may be allocated to a particular sub-region (e.g., Austin) of the second tier group 406a. Thus, if a request to perform an operation is issued against the third tier group 408, that request would be directed to the hardware components 420c, 420d arranged in the third tier group 408. However, if a request to perform an operation is issued against the first tier group 404b, that request would be directed to the hardware components 420c, 420d arranged in the third tier group 408 and the hardware component 420e arranged in the second tier group 406b because it has first tier group 404b as its ancestor.

The example above describes the hierarchical structure 400 arranged according to a hierarchy of geographical regions. Nevertheless, it should be appreciated that the structure may be arranged according to any suitable hierarchical structure. For example, the structure 400 may be arranged according to a device type of each of the hardware components. Examples of device types may include a form factor (e.g., laptop, desktop workstation, tablet, etc.), make/model of hardware component (e.g., Dell Optiplex 7085, Inspiron 2500, etc.), and the like. Other example structures may be arranged according to an entity that each of the hardware components are licensed to, or an intended function (web server, storage engine, virtualized network function, etc.) of each of the hardware components.

It may be important to note that the structure 400 may include a hierarchical structure arranged according to different criteria. For example, while the first tier group 404b is arranged according to a geographical location, the other first tier group 404a may be arranged according to a type of each hardware component. Because the structure 400 may include a hierarchical structure arranged according to different criteria, a single hardware component can be a member of more than one group.

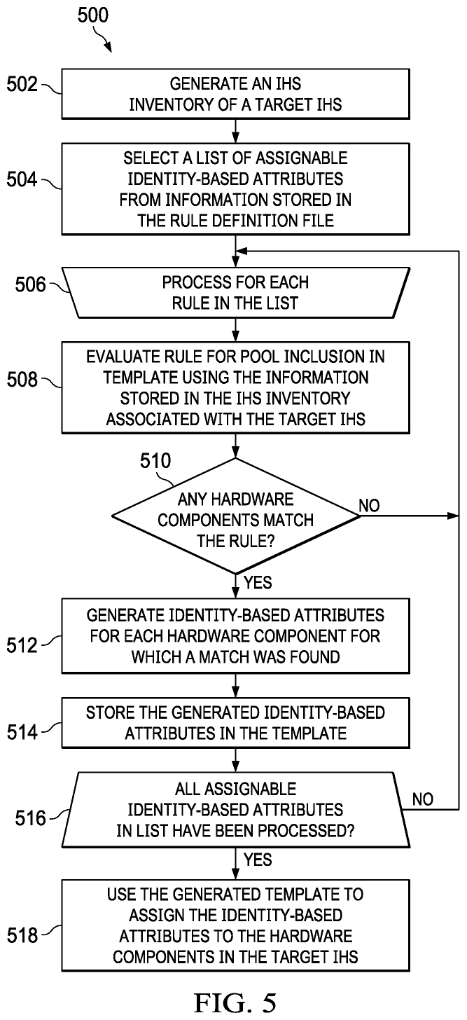

FIG. 5 illustrates a flowchart depicting certain steps of one embodiment of a dynamic identity assignment method 500 according to one embodiment of the present disclosure. In one embodiment, at least a portion of the steps of the method 500 may be performed by the systems manager 304 executed on a target hardware component 322. In another embodiment, the method 500 may be performed by a plugin that may be installed for use with a previously installed systems manager 304. Although the method 500 describes certain steps for generating a template 330 for a single IHS 320, it should be appreciated that the method 500 may be repeatedly performed for generating multiple templates 330 for a corresponding multiple number of IHSs 330.

Initially, a rule definitions file 328 is generated for one IHS 320 that includes rules associated with how certain identity-based attributes are to be assigned. For example, the user may populate the rule definition file 328 with rules associated with a location and/or position of the IHS 320 and/or its hardware components 322, a specific number pattern to be applied to be ports of an I/O module hardware component 322 based upon the configuration of its hardware component 322 in the IHS 320, a specific suffix to be applied to certain identity-based attributes based upon a configuration of its respective hardware component 322, and the like. Additionally, an IHS 330 is started (e.g., turned-up) and each of the hardware components 322 placed in service, such as being configured with certain end-use applications, coupled to a communications network, and booted to commence their operation.

At step 502, the method 500 generates an IHS inventory 310 of a target IHS 320. In one embodiment, the IHS inventory 310 may be generated according to a discovery process. Once generated, the IHS inventory 310 includes information about a configuration of the hardware components 322 and the IHS 320 that houses the hardware components 322. The configuration may be any characteristic associated with the hardware component 322. One such example characteristic may include a physical location (e.g., city, state, isle in a data center, mailing address, etc.) of the IHS 320 and its hardware components 322. Another example characteristic involves a particular physical ordered position of the hardware component 322 in its sled or chassis. Furthering this example, a hardware component 322 that is disposed in the fourth slot of a second sled, which is itself a hardware component 322 of the IHS 320, configured on the IHS 320 would be considered to comprise configuration characteristics of those hardware components 322. Yet another example characteristic involves a physical or logical quantity of I/O ports existing on that hardware component 322. Other example configurations may include a number and type of processing cores, a number and type of graphics processing units (GPUs), a non-volatile and well as volatile storage capacity, a type of Operating System (OS), a make and model of the hardware component 322, a type and number of user accounts established on the hardware component 322, and the like. In one embodiment, any groups that the hardware component 322 is configured in as well as any tags assigned to the hardware component 322 would comprise configuration characteristics of the hardware component 322.

At step 504, the method 500 selects a list of assignable identity-based attributes from information stored in the rule definitions file 328 associated with the IHS 320. To select the list of assignable identity-based attributes, the method 500 may successively iterate through all of the rules included in the rule definitions file 328 to identify those identity-based attributes that are assignable.

Steps 506-516 generally describe those operations that may be performed to generate a template 330 for its respective IHS 320. In particular, steps 506-516 may be performed for each assignable identity-based attribute in the list. The template 330 generally includes identity-based attributes 324 that are to be assigned to certain hardware components 322 in the IHS 320. For example, the present method 500 may be performed to create a number of templates 330 for each of a number of IHSs 320, and when completed, those templates 330 may each be used to assign identity-based attributes to the hardware components 322 of their respective IHSs 320.

At step 506, the method 500 processes the next rule in the list. That is, the method 500 may traverse through each rule in the list in which the rule being processed may be referred to as the current rule in the list.

At step 508, the method 500 evaluates rules for pool inclusion in template 330 using the information stored in the IHS inventory 310 associated with the target IHS 320. For example, the method 500 may iterate through each hardware component record 312 of the IHS inventory 310 to identify each hardware component having attributes matching the conditional clauses associated rule, and if so, apply the rule to that hardware component 322. In one embodiment in which the rule includes a conditional clause associated with group membership or a tag, the method 500 may also evaluate whether each hardware component record 312 includes a hardware component tag record 314 that matches a conditional clause associated with the rule, and if so, apply the rule to that hardware component 322. In another embodiment, the method 500 may evaluate any identity definitions indicating a specified range of values that each identity-based attribute 324 may possess.

At step 510, the method 500 determines whether any hardware components 322 match the rule (e.g., the conditional clauses associated with the rule) are met. If so, processing continues at step 512; otherwise processing continues at step 506 to process the next rule in the list. Some cases may exist in which a pool of identity definitions are extended beyond their allotted quantity (e.g., range) of values; that is, all of the allotted available identity-based attributes have been allocated. For example, the rule definitions file 328 may have 500 IP addresses allotted for assignment on the hardware components 322 of the target IHS 320, while a total of 540 IP addresses on the IHS 320 require assignment. In such cases, the method 500 may generate an error message indicating that the pool of identity definitions do not possess a sufficient range for handling all of the available IP addresses. In one embodiment, the method 500 may include the error message in the template 328 or other suitable mechanism for alerting the user of the problem.

At step 512, the method 500 generates identity-based attributes 324 for each hardware component 322 for which a match was found. Thereafter at step 514, the method 500 stores the generated identity-based attributes 324 in the template 328. At step 516, the method 500 determines whether all of assignable identity-based attributes in list have been processed. If so, processing continues at step 518; otherwise, processing continues at step 506 to process the next rule in the list.

At this point, all of the rules in the list have been processed an identity-based attributes 324 generated for each hardware component 322 in the target IHS 320. At a later point in time, the method 500 may use the generated template 328 to assign the identity-based attributes 324 to the hardware components 322 in the target IHS 320 at step 518. For example, the method 500 may iteratively cycle through each entry in the template 328 and communicate with each associated hardware component 322 in its respective IHS 320 to assign or otherwise update the identity-based attributes 324 according to its assigned value in the template 328.

The steps of the aforedescribed method may be repeatedly performed for dynamically assigning identity-based attributes for other IHSs 320. Nevertheless, when use of the dynamic identity assignment system method 500 is no longer needed or desired, the process ends.

While FIG. 5 describes an example method that may be performed for dynamically assigning identity-based attributes for the hardware components 322 of a IHS 320, the features of the method 500 may be embodied in other specific forms without deviating from the spirit and scope of the present disclosure. For example, the method 500 may perform additional, fewer, or different operations than those described in the present examples. As another example, the sequence in which steps of the aforedescribed process may be performed should not be limited thereto as it is contemplated that other embodiments that the disclosed steps may be performed in a different order or sequence without departing from the spirit and scope of the present disclosure.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a plurality of hardware components each having at least one identity-based attribute; and
computer-readable instructions stored in at least one memory and executed by at least one processor to:
obtain an inventory of the hardware components, wherein the inventory comprises information associated with a configuration of each of the hardware components in the IHS;
receive one or more rule definitions; and
for each of the hardware components:
generate an identity-based attribute for the hardware component by matching the configuration of the hardware component with at least one of the rule definitions; and
assign the generated identity-based attribute to the hardware component.

2. The IHS of claim 1, wherein the instructions are further executed to generate the identity-based attribute by selecting the identity-based attribute from a pool of available identity-based attributes.

3. The IHS of claim 1, wherein the instructions are further executed to obtain the inventory of the hardware components by performing a discovery operation on the IHS.

4. The IHS of claim 1, wherein the instructions are further executed to generate a template comprising a plurality of the identity-based attributes, wherein the template is used to assign the identity-based attributes to their respective hardware components.

5. The IHS of claim 1, wherein the instructions are further executed to, when no match for the configuration of the hardware component, generate an error message.

6. The IHS of claim 1, wherein the instructions are further executed to generate the identity-based attribute according to a tag associated with the hardware component.

7. The IHS of claim 6, wherein the tag is associated with a group designation of the hardware component.

8. The IHS of claim 1, wherein the identity-based attribute comprises at least one of an IP address of the hardware component, a MAC address of an Ethernet port configured on the hardware component, a World Wide Name (WWN) of a storage component configured on the hardware component, a world Wide Port Name (WWPN) used to uniquely identify an I/O port configured on the hardware component, an iSCSI initiator identifier, an iSCSI initiator IP address, a portion of a name assigned to the hardware component or a component of the hardware component.

9. The IHS of claim 1, wherein the configuration of the hardware component comprises at least one of a physical location of the hardware component, physical ordered position of the hardware component, a physical or logical quantity of I/O ports existing on the hardware component, a number and type of processing cores, a number and type of graphics processing units (GPUs), a non-volatile or volatile storage capacity, a type of Operating System (OS), a make and model of the hardware component, a type and number of user accounts established on the hardware component, a tag associated with the hardware component.

10. A dynamic identity assignment method comprising:
obtaining, using instructions stored in at least one memory and executed by at least one processor, an inventory of a plurality of hardware components of an Information Handling System (IHS), wherein the inventory comprises information associated with a configuration of each of the hardware components in the IHS;
receiving, using the instructions, one or more rule definitions; and
for each of the hardware components:
generating, using the instructions, an identity-based attribute for the hardware component by matching the configuration of the hardware component with at least one of the rule definitions; and
assigning, using the instructions, the generated identity-based attribute to the hardware component.

11. The dynamic identity assignment method of claim 10, further comprising generating the identity-based attribute by selecting the identity-based attribute from a pool of available identity-based attributes.

12. The dynamic identity assignment method of claim 10, further comprising obtaining the inventory of the hardware components by performing a discovery operation on the IHS.

13. The dynamic identity assignment method of claim 10, further comprising generating a template comprising a plurality of the identity-based attributes, wherein the template is used to assign the identity-based attributes to their respective hardware components.

14. The dynamic identity assignment method of claim 10, further comprising, when no match for the configuration of the hardware component, generating an error message.

15. The dynamic identity assignment method of claim 10, further comprising generating the identity-based attribute according to a tag associated with the hardware component.

16. The dynamic identity assignment method of claim 15, wherein the tag is associated with a group designation of the hardware component.

17. A systems manger appliance comprising:
computer-readable instructions stored in at least one memory and executed by at least one processor to:
obtain an inventory of a plurality of hardware components each having at least one identity-based attribute, wherein the inventory comprises information associated with a configuration of each of the hardware components in an Information Handling System (IHS);
receive one or more rule definitions; and
for each of the hardware components:
generate an identity-based attribute for the hardware component by matching the configuration of the hardware component with at least one of the rule definitions; and
assign the generated identity-based attribute to the hardware component.

18. The systems manger appliance of claim 17, wherein the instructions are further executed to generate the identity-based attribute by selecting the identity-based attribute from a pool of available identity-based attributes.

19. The systems manger appliance of claim 17, wherein the instructions are further executed to generate a template comprising a plurality of the identity-based attributes, wherein the template is used to assign the identity-based attributes to their respective hardware components.

20. The systems manger appliance of claim 17, wherein the instructions are further executed to generate the identity-based attribute according to a tag associated with the hardware component.
